(19) United States
(12) Patent Application Publication
(10) Pub. No.: US 2017/0098195 A1
(43) Pub. Date: Apr. 6, 2017

(54) Dynamic Geofence Determination

(71) Applicant: 2e Systems GmbH, Bad Soden am Taunus (DE)

(72) Inventors: Philip Milton Douglas, Kelkheim-Ruppertshain (DE); Andrew Robert Hurst, Zagreb (HR); Elke Heynert, Frankfurt (DE); Marija Tomic, Zagreb (HR); Milan Velikic, Frankfurt am Main (DE); Zeljko Sucic, Zagreb (HR); Miljenko Brkic, Zagreb (HR)

(21) Appl. No.: 15/379,556

(22) Filed: Dec. 15, 2016

Related U.S. Application Data
(63) Continuation-in-part of application No. PCT/IB2015/001584, filed on Jun. 29, 2015.
(60) Provisional application No. 62/018,795, filed on Jun. 30, 2014.

(51) Int. Cl. G06Q 10/10; H04W 4/02

(52) U.S. Cl. CPC G06Q 10/1093; H04W 4/022

(57) ABSTRACT

A system for dynamic geofence determination for trip navigation comprises an interface and a microprocessor. The interface is configured to receive data for one or more trips. The microprocessor is configured to determine an initial node for each trip based on the data; determine an initial time window for each trip associated with the interface; and determine a dynamic geofence for the initiation of each trip. A dynamic geofence is operable only during its initial time window. The system may have a location sensing device, such as a global positioning system. Trips may be automatically initiated when the interface is within a dynamic geofence during its initial time window.

### TECHNICAL FIELD

The inventions described herein are in the field of navigation.

### BACKGROUND ART

Geofences that change in response to changing trips are difficult to implement particularly when the trips must be initiated during an initial time window. There is need, therefore, for dynamic geofence determination for trips that change wherein the dynamic geofences are operable to confirm initiation of said trips by users during said initial time windows.

### SUMMARY OF INVENTION

The disclosure of invention is provided as a guide to understanding the invention. It does not necessarily describe the most generic embodiment of the invention or the broadest range of alternative embodiments.

FIG. 25 illustrates a system 2500 for dynamic geofence determination. The system comprises an interface 2502 configured to receive data 2510 for one or more trips. It also comprises a first microprocessor 2504 configured to determine an initial node 2512 for each trip; determine an initial time window 2514 for each trip; and determine a dynamic geofence 2516 for each trip based on said initial nodes and operable during said initial time windows. An example of an interface is a mobile device such as a smart phone. An example of a first microprocessor is a microprocessor of a mobile device. As used herein, “trips” may be referred to as “schedule items”.

The system may be further configured to comprise a location sensor 2506. An example of a location sensor is a global positioning system (GPS). The location sensor can determine 2522 if the system is within a dynamic geofence during an initial time window. The system may then receive 2524 through the interface 2502 an indication that a user has initiated a first trip when the location is within a dynamic geofence during its initial time window. The system can then confirm 2526 to the user that the trip has been initiated. As used herein, the step of initiating a trip may be referred to as “checking in” or “a check-in”. A user may be referred to herein as a “crew member”. The initial time window for checking in may be between a check-in time and a reporting time for an airline flight. An initial node may be located (e.g. latitude and longitude) in an airport that a flight departs from. A geofence for checking in may be a radius around an initial node in the airport.

The system may be further configured to receive an update to the data for one or more trips; change at least one of the initial nodes or initial time windows based on the update; and update the dynamic geofences based on the changes to the initial nodes or initial time windows. As used herein, an update to the data for one or more trips may be referred to as a “new schedule item extract”.

The interface may be further configured to accept a login by a user and confirm the user's identity. The first microprocessor may be further configured to automatically initiate a first trip when the interface is within the dynamic geofence associated with said first trip during the initial time window associated with said first trip.

FIG. 1 illustrates a notification system 100 for notifying persons of schedule changes as well as schedule items. The system comprises a computer based middleware server 104 and one or more computer based mobile devices 106. The middleware server is in communication with a computer based scheduling system 102. The middleware server comprises a middleware database 116 and optional middleware cache 114. The middleware cache may comprise individual caches such as a schedule item cache, query key cache and group key cache. The schedule item cache may comprise prior query results on the middleware database related to a person's schedule items. The query results may be labeled by a query key. The query key cache may comprise a list of query results in the schedule item cache related to a particular query key. There may be different types of queries. Each type of query may be labeled with a group key. The group key cache may comprise a list of queries associated with a group key. Each mobile device comprises a screen 101 or other output device for outputting information to a person 108. The person may be a crew member of an airline crew. The notification systems described herein, however, may be used to notify any set of people. The mobile devices also each comprise an input device 103, such as a keyboard, touch screen, voice or gesture recognition system or any other form of human operable input device. Mobile devices include lap tops 122, tablets 124 and cell phones 126. Cell phones may include smart phones, such as an Apple® iPhone®. Any computer implemented mobile device with wireless communications capabilities, however, may be used, such as smart watches, smart glasses or other wearable or portable devices. Each mobile device may be registered to a particular person so only that person is authorized to use it. The registration may be provided and recorded by the middleware server.

In operation, the scheduling system 102 receives a schedule update 132 from a scheduler 112. In the airline industry, the scheduler may be referred to as crew support services. The scheduling system may be a large enterprise system such as Sabre CrewTrac®. The scheduling system maintains up to date schedules for a set of persons, such as the crew members of an airline. On a periodic basis, such as every 5 minutes, schedule item extracts 136 are provided to the middleware server. These tend to be large files since they comprise complete snapshots of all crew members' schedule items at a given time. Extracts, however, may be any sort of data feed from the scheduling system to the middleware server. The middleware server compares the most recent extract, termed the “new extract”, with the immediate prior extract, termed the “old extract”, that had been previously saved in the middleware database 116. As will be described in more detail below, the middleware server determines which schedule items have changed for which crew members. Alternatively, the scheduling system may directly provide schedule changes to the middleware server. The middleware server also determines which unchanged schedule items overlap the changed schedule items and bundles the overlapping changed and unchanged schedule items into single schedule change records. The schedule change records are pushed as notifications 142 to one or more of the mobile devices of the crew members. Some notifications are informational only. Other notifications require an acknowledgement 144 or other action by a crew member 108. The push notifications may be by one or more push technologies, such as email (EML) 131, app push (APP) 133 or short message service (SMS) 135. Any push technology, however, may be used, such as automated voice dialing to a phone. If the notification requires an acknowledgement, then the acknowledgement can be sent back to the middleware server by an appropriate technology such as a deep link in an email 121, app communication via the internet 123 or a response SMS 125. The response SMS may comprise a random response code provided by the original SMS 135 pushed to the crew member. Any form of human operable technology, however, may be used to provide an acknowledgement, such as voice or gesture recognition.

Once an acknowledgeable notification has been acknowledged, the middleware server may notify 146 the scheduling system of the acknowledgement and send a confirmation back to the mobile device(s) acknowledging the confirmation. This closes the loop of the notification.

For mobile devices with an app 124, the middleware server may additionally push schedule items to be displayed in a calendar view on the screen of the mobile device. As used herein, an app is an application program that runs on a mobile device. The schedule items for airline crew members displayed in a calendar view might be one or more of a pairing or non-flight activity. As used herein, a pairing is a set of one or more flights that an airline crew member is assigned to. Pairing are often, but not necessarily, round trips from a crew member's home base. A crew member's home base is a location in an airport near where the crew member lives and is typically the location where a crew member checks in for a pairing.

### Calendar View on Mobile Devices with Apps

A mobile device with an app can display the pairings and activities on a calendar view. It is advantageous, therefore, to associate schedule items with schedule changes so that when schedule items are displayed in a calendar view, a visual indication of a schedule change can be displayed in proximity to the visual representation of the affected schedule item. As used herein, a schedule item is a set of data that describes an activity or event that has a start time and end time. An example is a flight a crew member might be assigned to. A schedule change is a difference between an initial schedule item and a modified or new schedule item that overlaps the initial schedule item in time. A schedule change record is a set of data that describes a schedule change.

The schedule items used to create a calendar view may be sent to a mobile device after the app on the device is launched. The app sends an update request to the middleware server for current schedule items related to a particular crew member for a particular time period, such as a month. The middleware server returns the current schedule items to the mobile device. The schedule items can be retrieved directly from the middleware database 116 with a query, such as an SQL query. The query might specify a crew member ID and time period. Once query results are returned from the middleware database to the middleware server, they may be saved in the schedule item cache of the middleware cache 114 with a version number. The version number may also be provided to the mobile device and stored in the mobile device.

The cached queries may be updated as new schedule item extracts are processed. Each time a schedule change is detected for a crew member, the crew member's version number is incremented. This version number for the crew member is termed a “global version number”. If a future schedule update request for current schedule items comes in from a mobile device, it would have the old version number for the schedule items previously stored on the mobile device. If the old version number from the mobile device matches the current version number for the same query in the schedule item cache, then a confirmation code is returned to the mobile device and the mobile device knows the previously received schedule items are up to date. If the version numbers are different, then the cached query results are returned to the mobile device along with the current version number. These are then stored on the mobile device. The earlier version of the schedule items may be discarded to save memory space.

Cached data may be stored by calendar month or other convenient or appropriate time period. The version numbers for cached query results for different months, therefore, may be different depending upon how long ago the schedule items in a particular month were updated.

The schedule item cache within the middleware cache 114 may be updated after a new extract 136 from the scheduling system 102. When a difference in a crew member's schedule is detected, the cache for the month that the changed schedule item is in may be updated by the change. If a schedule item spans more than one calendar month, then the caches for all of the months that the schedule item spans may be updated.

Each time a schedule change is detected for a crew member, the crew member's global version number may be incremented. If a cache for a particular month is updated, the version number for the cache is set to the global version number. Thus different months in the cache will have different version numbers depending upon what the global version number was when a given month's cache was updated. This makes the system more efficient since requests for months with older version numbers will result in confirmation codes being sent instead of resending the cache contents, even though other months have had schedule changes.

From time to time, the entire contents of the cache may be refreshed from the latest extract from the scheduling system. This may be done once every 24 hours or other time period. This helps ensure that errors do not creep into the cache due to undetected schedule changes or other errors.

Other intermediary computer based systems are inherent in the notification system 100. These include front end servers for routing information from the middleware server to the mobile devices, intervening cellular networks, WiFi, LAN and other communications systems.

### BRIEF DESCRIPTION OF DRAWINGS

FIG. 1 illustrates a notification system for notifying persons of schedule changes as well as schedule items.

FIG. 2 illustrates a middleware algorithm for processing a new schedule item extract.

FIG. 3 illustrates the algorithm used by the middleware server to determine what schedule items should be sent to a mobile device running a mobile app.

FIG. 4 is a time line of overlapping changed pairings.

FIG. 5 is a timeline of a “pairing to multi” schedule change record.

FIG. 6 is a timeline which illustrates the algorithm that may be used to set an event time for a schedule change record.

FIG. 7 is a timeline of a schedule change record that shows how event time is determined when a pairing has already started when the schedule change is detected.

FIG. 8 is a timeline which shows how event time periods may be adjusted for different classes of crew members.

FIG. 9 is a push strategy lookup table that may be stored on a middleware database to determine an appropriate push strategy for a schedule change record depending upon the event time period a schedule change lands in or rolls from.

FIG. 10 shows an exemplary home screen icon for a notification system mobile app.

FIG. 11 shows a suitable calendar view on a mobile device screen.

FIG. 12 shows a calendar view when the schedule notification/check-in icon has been selected by a crew member.

FIG. 13 shows a calendar view when a schedule change notification has been selected by a crew member.

FIG. 14 shows a calendar view when a check-in reminder notification has been selected by a crew member.

FIG. 15 shows a calendar view when the hotel/transport change icon has been selected by a crew member.

FIG. 16 shows a calendar view when a hotel/transport change notification has been selected by a crew member.

FIG. 17 shows a calendar view when the operational update icon has been selected by a crew member.

FIG. 18 shows a calendar view when an operational update notification has been selected by a crew member.

FIG. 19 shows a calendar view when a calendar ribbon has been selected by a crew member.

FIG. 20 shows a calendar view when a utility icon has been selected by a crew member.

FIG. 21 shows a calendar view when a what's next icon has been selected by a crew member.

FIGS. 22A and 22B present version lookup tables indicating how version numbers for schedule cache time intervals are updated.

FIGS. 23A and 23B show query results that may be saved in particular months of a crew member's schedule item cache.

FIG. 24A illustrates a query key cache for a particular query, “Query 1”.

FIG. 24B illustrates a group key cache.

FIG. 25 illustrates a system for dynamic geofence determination.

### DETAILED DESCRIPTION

The detailed description describes non-limiting exemplary embodiments. Any individual features may be combined with other features as required by different applications for at least the benefits described herein. As used herein, the term “about” means plus or minus 10% of a given value unless specifically indicated otherwise.

A portion of the disclosure of this patent document contains material to which a claim for copyright is made. The copyright owner has no objection to the facsimile reproduction by anyone of the patent document or the patent disclosure, as it appears in the patent file or records, but reserves all other copyright rights whatsoever.

As used herein, a “computer based” system comprises an input device for receiving data, an output device for outputting data in tangible form (e.g. printing or displaying on a computer screen), a permanent memory for storing data as well as computer code, and a microprocessor configured to execute said computer code wherein said computer code resident in said permanent memory will physically cause said microprocessor to read-in data via said input device, process said data within said microprocessor and output said processed data via said output device. Computer code causing a microprocessor to execute one or more steps may be referred to herein as an “app”.

Elements of computer based systems, such as databases or caches, are shown as distinct items. The elements can physically be divided amongst a plurality of individual pieces of hardware, such as the distribution of a database among various database servers. Conversely, items that are described separately, can be physically combined. For example, different caches can be combined and stored on a single permanent memory.

The examples provided herein generally are prophetic examples notwithstanding the use of past tense or future dates. Actual examples will be specifically identified as such.

### Middleware Algorithms

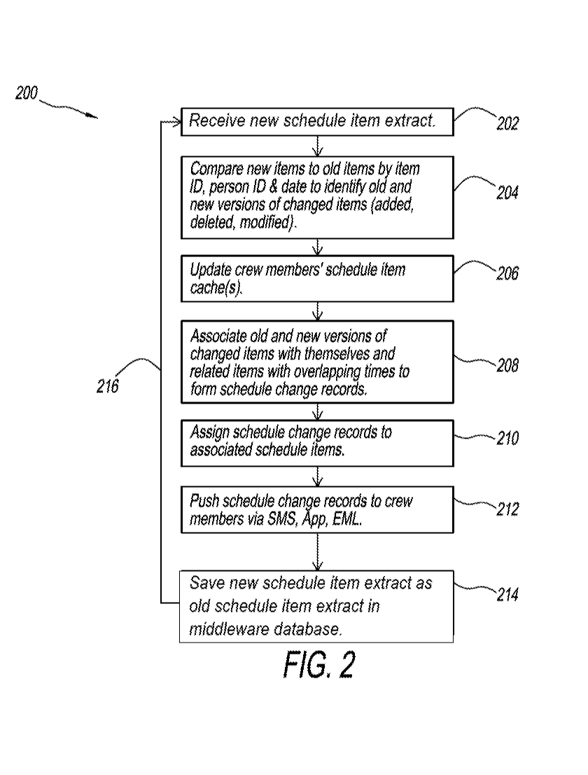

FIG. 2 illustrates a middleware algorithm 200 for processing a new schedule item extract. In this example, a schedule item is a record of data that comprises the fields:
Item ID
Crew Member ID or person ID
Date (standard time)
Start time (local time)
End time (local time)
Description

If the schedule item describes a pairing, then the Item ID may be a pairing ID assigned by an airline. A pairing ID may have the form “J1234B” where J corresponds to the first letter of the crew member's home base, 1234 corresponds to a numerical identifier of the pairing and B corresponds to the version number of the pairing. The version number may be blank for the initial version of a pairing. Any form of item ID, however, may be used. Crew member ID may be a crew member employee number assigned to a crew member by an airline. Any form of crew member ID may be used. ID's do not have to be for crew members only but for any person that may need schedule notifications. Date (standard time) is the date the pairing begins on. The date may be according to a standard time, such as UTC or Zulu time. Start time (local time) may be the start time of a pairing according to the local time in the time zone of the crew member's home base. End time (local time) may be the local time of a pairing ending according to the time zone of the airport the pairing ends at. It is advantageous to have start times and end times expressed in local times since those are the times persons need to keep in mind for coordinating their schedules according to the clocks at the locations where they will be. This is advantageous despite the fact that when activities are presented as blocks of time on a calendar, the length of the blocks will not necessarily correspond to the actual duration of the activities. Airline crews, however, are used to coordinating their schedules according to local times. The “Description” field is a catch all for the other fields that may provide descriptive information about a schedule item. It may include settable fields, such as an acknowledgement field that indicates whether or not a crew member has acknowledged receipt of information about the schedule item. It may also include a check-in field indicative of whether or not a crew member has checked in for a given schedule item.

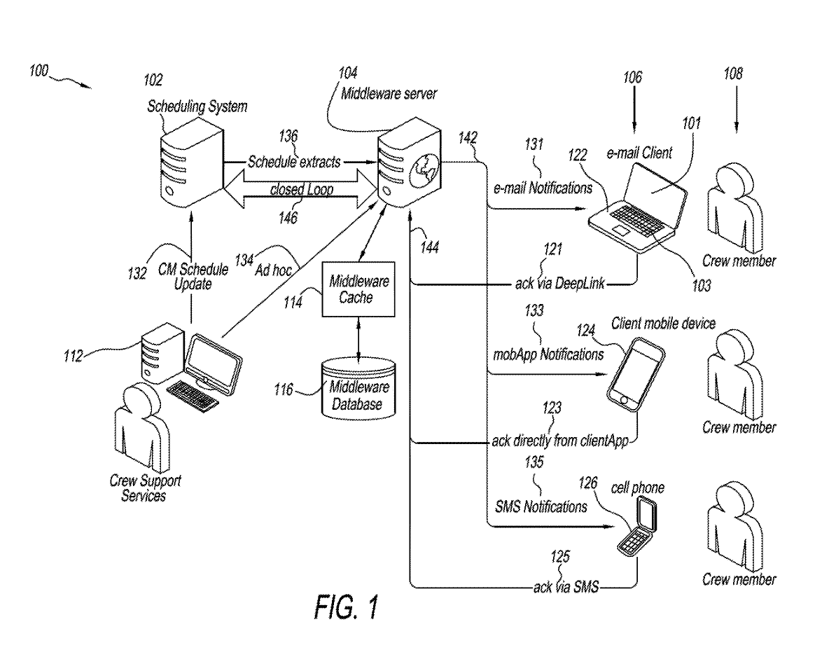

The process starts once the middleware server receives a new schedule item extract 202. It then compares 204 the items in the new extract with the items in the prior extract (i.e. “old extract”) stored in the middleware database (item 116 FIG. 1) to determine what schedule items, if any, have changed. The algorithm uses at least the item ID, person ID and date to look for schedule items that have either been added (i.e. in new extract but not old extract), been deleted (i.e. in old extract but not in new extract) or been modified (e.g. item ID, person ID and date match, but fields within schedule item record have changed, such as start time).

Once changed items have been identified for a crew member, the global version number for the crew member is increased and the algorithm updates 206 cached queries for said crew member. This presumes a cache is used. If there is no cache, then this step is skipped.

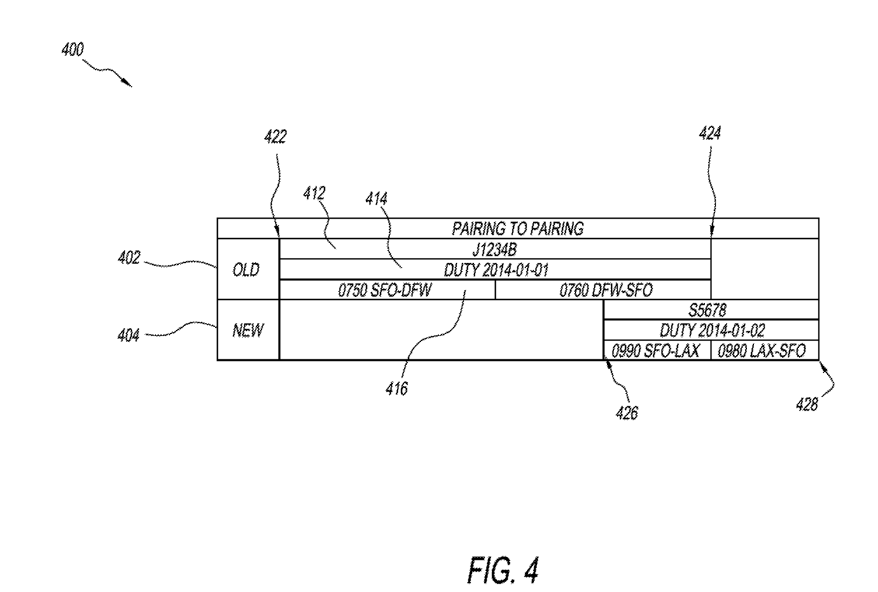

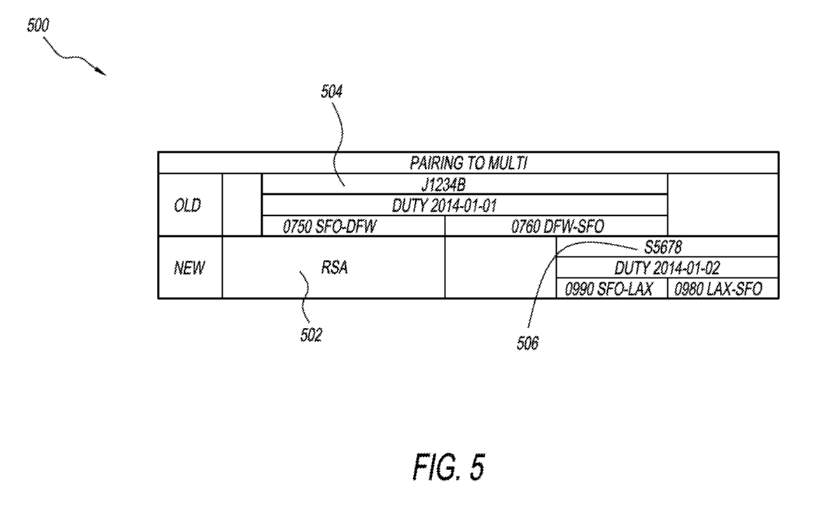

The algorithm then associates 208 old and new versions of changed schedule items with each other based on overlapping start and end times. The start and end times may be converted to a standard time such as UTC to avoid time zone effects. The algorithm also checks to see if any unchanged schedule items also overlap the changed schedule items. A schedule change record is built from each set of mutually overlapping schedule items. This will be discussed in more detail with regard to FIGS. 4 and 5.

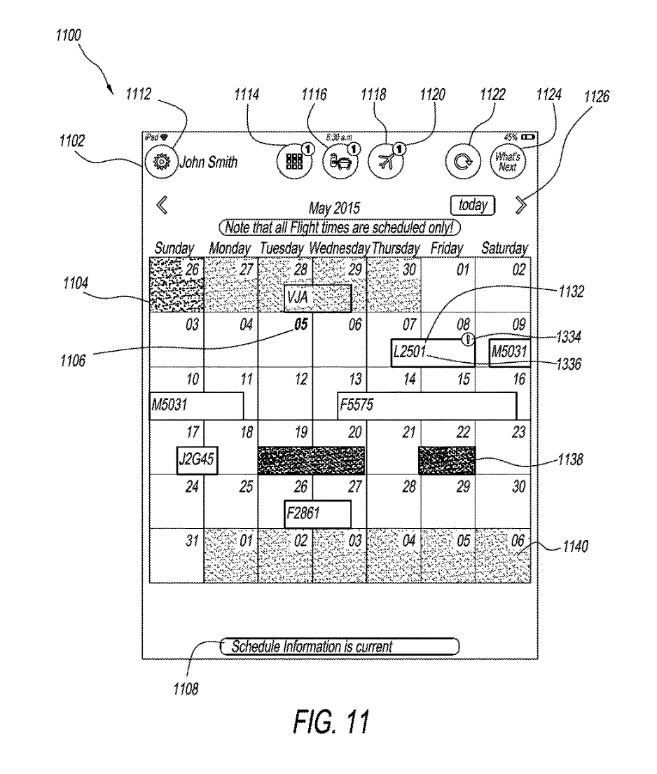

Once a schedule change record is built, it is assigned 210 to one or more associated schedule items. The assignment may be indicated in one or more fields of the schedule change record. The assignment is advantageous for a mobile app that presents schedule items on a calendar view. A visual indication can be presented on the schedule item on the calendar to indicate that there is an associated schedule change. This is discussed in more detail with reference to FIG. 11.

The schedule change records may then be pushed 212 to a crew member by one or more of a variety of means such as email, app push or SMS. Additional activities, such as confirmation of delivery and receipt of crew member acknowledgements, may also take place.

The new schedule item extract is then stored 214 in the middleware database as the old schedule item extract. The previous old schedule item extract may be archived or discarded.

The algorithm then repeats 216 when a new schedule item extract is received by the middleware server.

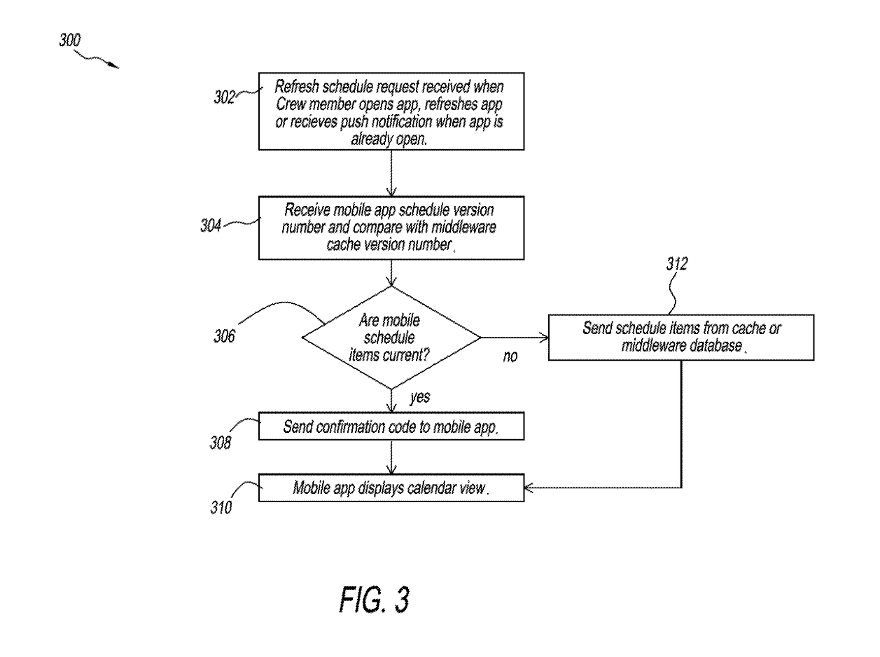

FIG. 3 illustrates an algorithm 300 used by the middleware server to determine what schedule items should be sent to a mobile device running a mobile app. The middleware server receives 302 a refresh schedule request from the mobile app. A “refresh schedule request” is also termed a “schedule update request”. The mobile app may generate the refresh request whenever it is launched, whenever the crew member requests a refresh or shortly after the middleware server pushes a schedule change record to the mobile app if the app is open and running. The mobile device can also be configured to send the request if the mobile app is running in background.

The middleware server receives 304 a mobile app schedule version number along with the refresh request. A “mobile app schedule version number” is also termed an “old version number”. The mobile app version number is associated with the crew member and a time period. The middleware server checks the schedule item cache to determine the schedule item cache version number for the same crew member and time period. A “schedule item cache version number” is also termed a “current version number”. If the version numbers match 306, then the mobile schedule items are current and a confirmation code 308 is returned to the mobile app. If the numbers 312 don't match, then the current schedule items from the cache are returned to the mobile app along with the current cache version number. If there are no items in the cache, then the middleware server queries the middleware database to collect the schedule items in the specified time period and forwards them to the mobile app. The middleware server may then cache the results of the newly executed query.

If the mobile app received a confirmation code, then the calendar view is displayed 310 using the schedule item records already on the mobile device. Thus the total amount of data transfer and associated cost and bandwidth at the middleware server is reduced. If the app receives an updated set of schedule items along with an updated version number 312, then the calendar view is created with the updated items and the records for the updated items are stored on the mobile device along with the updated version number from the schedule item cache. The prior data on the mobile device may be discarded to reduce demands on the mobile device data storage.

### Building Schedule Change Records

FIG. 4 is a time line 400 of overlapping changed schedule items. The timeline shows a top bar 402 of schedule items from an old schedule item extract. The bottom bar 404 shows schedule items from a new schedule item extract. These particular items are pairings. Pairings are represented by a top sub-bar 412 indicating a pairing number, a middle sub-bar 414 indicating one or more duties within a pairing, and a bottom sub-bar 416 indicating one or more flights within the one or more duties. Each pairing has an ID, a start time 422, 426 and a stop time 424, 428. The old pairing J1234B has been cancelled and the new pairing S5678 has been added. They could each be reported to a crew member as separate schedule change records and the crew member would have two records to acknowledge or view. The start time 422 and stop time 424 of the old pairing, however, overlap the start time 426 and stop time 428 of the new pairing. Thus the old pairing and the new pairing can be sent to a crew member as a single pairing to pairing change. Both pairings, therefore, are placed in the same schedule change record and pushed to the crew member as a single change. This reduces the demands on a crew member's time since the crew member can review and respond to a single communication instead of multiple communications. This also reduces the costs to the airline since they may be paying for notifications on a “per notification” basis.

FIG. 5 is a timeline 500 of a “pairing to multi” schedule change record. The old pairing 504 and new pairing 506 are the same as in FIG. 4. An additional non-flight activity 502, however, has also been added to the schedule with a start time and stop time that overlaps the old pairing. As long as any old schedule item overlaps any one of the new schedule items, then the schedule items are grouped together as one schedule change record. In this case, the total number of notifications pushed to a crew member is reduced by a factor of 3 and the overall system technical performance is improved in terms of push notifications required.

In addition to additions and deletions of schedule items, changes within schedule items can also be detected. Thus if an initial version of a pairing J1234B is changed, such as by changing a departure time, said change will be detected and the initial version of the pairing and the updated version of the pairing will be added to the same schedule change record and pushed to the crew member as a single change.

A taxonomy of schedule change types can be created to help facilitate categorization of schedule changes. An exemplary categorization is illustrated in table 1. Alternative categorizations may be used for different sets of persons who are being informed of schedule changes of a different nature. Different sets of people might include health care workers, public service personnel, factory workers and military personnel.

TABLE 1

| Type | Description |
|---|---|
| ACTIVITY TO ACTIVITY | 1 Activity is replaced with 1 Activity. |
| ACTIVITY TO MULTI | 1 Activity is replaced with multiple items of any type. |
| ACTIVITY TO PAIRING | 1 Activity is replaced with 1 Pairing. |
| MULTI TO ACTIVITY | Multiple items of any type are replaced with 1 Activity. |
| MULTI TO MULTI | Multiple items of any type are replaced with multiple items of any type. |
| MULTI TO PAIRING | Multiple items of any type are replaced with 1 Pairing. |
| PAIRING TO ACTIVITY | 1 Pairing is replaced with 1 Activity. |
| PAIRING TO MULTI | 1 Pairing is replaced with multiple items of any type. |
| PAIRING TO PAIRING | 1 Pairing is replaced with 1 Pairing. |
| REPORT TIME CHANGE | Pairing Modification. Change in Report Time (related to Duty |
| | Period/Duty Day). No flights added or removed. It does not matter |
| | if the Pairing has started or not. |
| Flight Added/Removed | Pairing Modification. Any number of flights removed or added into |
| | the pairing. No change in report times of any duty in the pairing. |
| SBY Added | Pairing Modification. The Code “SBY” is added as the first line into a |
| | pairing (used for FAR 117). Pilots are able to stay at the hotel for a |
| | longer amount of time. |
| Multiple Changes in a Pairing | Pairing Modification. Multiple changes consisting of flight, activity |
| | code and report time manipulation. |
| PAIRING TO NOTHING | Pairing has been changed to a non-monitored activity or removed |
| | without a replacement assignment. |
| ACTIVITY TO NOTHING | Activity has been changed to an non-monitored activity or removed |
| | without a replacement assignment. |
| NOTHING TO PAIRING | A crew member with an non-monitored activity code or without an |
| | assignment is assigned to a pairing. |
| MULTI TO NOTHING | Multiple consecutive items have been removed from the schedule |
| | without replacement assignments. Note - This only applies if the |
| | items being removed are “back to back” e.g. 3 RSV activities on 3 |
| | consecutive days are removed at the same time. |
| NOTHING TO MULTI | Multiple consecutive items have been added to the schedule where |
| | there was nothing before. Note - This only applies if the items being |
| | added are “back to back” e.g. 3 RSV activities on 3 consecutive days |
| | are added at the same time. |

### Event Time Determination

Once a middleware server creates a schedule change record, an event time can be associated with it. As used herein, an event time is a time associated with a schedule change record that determines how notifications of a schedule change are pushed to the mobile device of a crew member or other person. If a schedule change record is created at the current time, the closer the current time is to the event time, the more urgent the need is to notify a crew member and get said crew member's acknowledgement (if necessary) of said schedule change. Event time periods may be defined relative to an event time. A first event time period might be defined relatively far in advance of an event time, such as 1.5 to 7 days before said event time. A second event time period might be defined closer to an event time, such as 3 hours to 1.5 days before said event time. A third event time period might be defined as closest to an event time, such as 0 to 3 hours before said event time. A third event time period may extend past an event time to an expiration time. An expiration time may be defined as the time which a crew member or other person can no longer act on a schedule change. Schedule changes that occur before the first event time period may be held by the middleware server until the first event time period begins and then pushed to a crew member accordingly. The number and duration of the event time periods may be configurable. An airline, for example, may define how many periods there are for each type of crew member job function and under what work conditions (e.g. irregular operation (IROP) when there are widespread disruptions or normal work schedule). These can be forwarded to the middleware server.

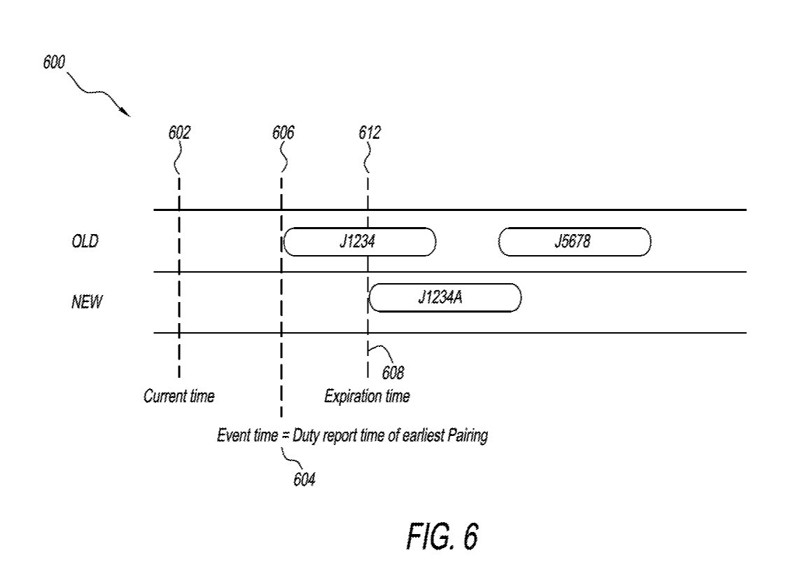

FIG. 6 is a timeline 600 which illustrates an algorithm that may be used to set an event time for a schedule change record. The guiding principle is that the event time should be set at the earliest time that a crew member must either take an action, such as check-in for a new pairing, or not take a previously scheduled action, such as check-in for a cancelled pairing. In FIG. 6 for example, an old version of a pairing J1234 has been updated with a new version J1234A. The new version has a check-in time 612 which is later than the check-in time 606 for the original version of the pairing. The event time 604 is therefore set to the earlier check-in time since the goal is to make sure the crew member is informed before the crew member mistakenly reports to the original check-in time. If the new version of J1234A had an earlier check-in time than the original version of J1234, then the event time would have been set to the earlier check-in of J1234A to make sure the crew member was available for the earlier check-in. The current time 602 in FIG. 6 refers to the time that the schedule change was detected by the middleware server. The event time period that the current time falls in will be measured from the event time. This will determine the appropriate push strategies to the crew member.

The middleware server will also assign an expiration time for the schedule change record. The expiration time may be set to the latest time that a crew member must take or not take an action. In the case illustrated in FIG. 6, the check-in time for the new version of pairing J1234A is set as the expiration time 608. Once the expiration time has passed, the middleware server will no longer attempt to push a schedule change record to a crew member or accept a notification from a crew member regarding a schedule change record.

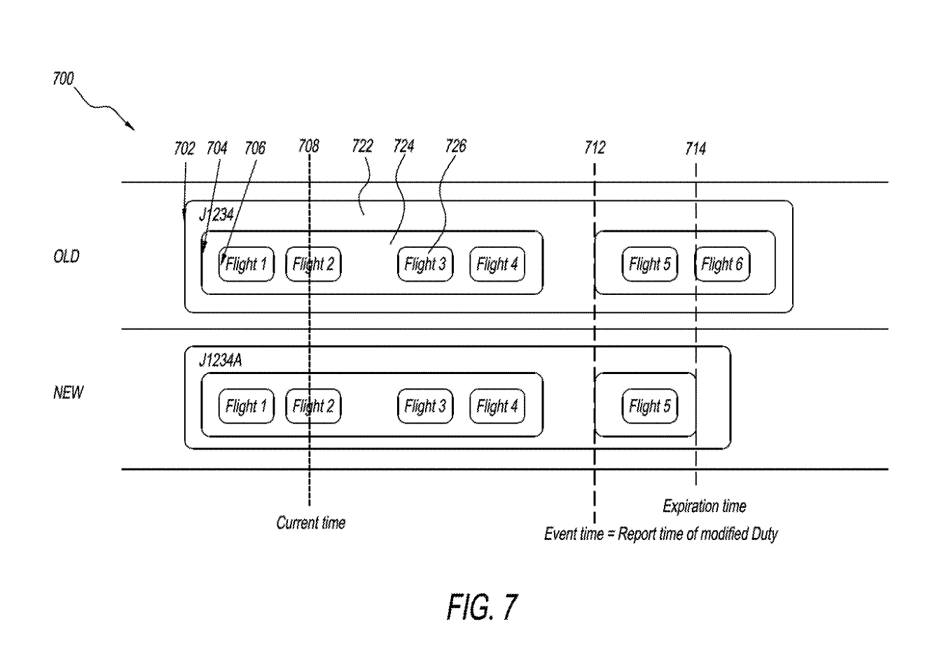

FIG. 7 is a timeline 700 of a schedule change record that shows how event time is determined when a pairing has already started when the schedule change is detected. The bar for the pairings has been expanded to show the time for the overall pairing 722, the time for the duty periods 724 within the pairing and the time for the flights 726 within a duty period. The start time for a pairing 702 is termed the check-in time for the pairing. The start time for a duty 704 is termed the report time for a duty. The start time for a flight 706 is termed the report time for a flight. These times may be the same, such as the check-in time for a pairing, the report time for the first duty of a pairing and the report time for the first flight of the first pairing. In FIG. 7, a new version of the pairing, J1234A, has been detected by the middleware server in a new extract at the current time 708. The pairing J1234 has already begun and the crew member is on Flight 2. The change in schedule is the cancellation of Flight 6 in the second duty period. The earliest time when the crew member must make a change in action is the report time of the modified second duty period. This therefore is set to the event time 712. The expiration time for the schedule change record is set to the departure time 714 of the cancelled flight 6. This is the latest time that the crew member could take an action (e.g. not report for a previously scheduled fight) relative to the time the schedule change was detected.

### Event Time Period

One or more event time periods may be defined prior to an event time to determine what strategy is used to push a schedule change record to a crew member or other person. As described above, a first event time period, period 1, may be defined relatively far in advance of an event time when the urgency of notifying a crew member and receiving an acknowledgement or other response from the crew member is relatively low. A second event time period, period 2, may be defined as being moderately close to an event time. A third event time period, period 3, may be right on top of an event time and even extend up to an expiration time. This period has the highest urgency.

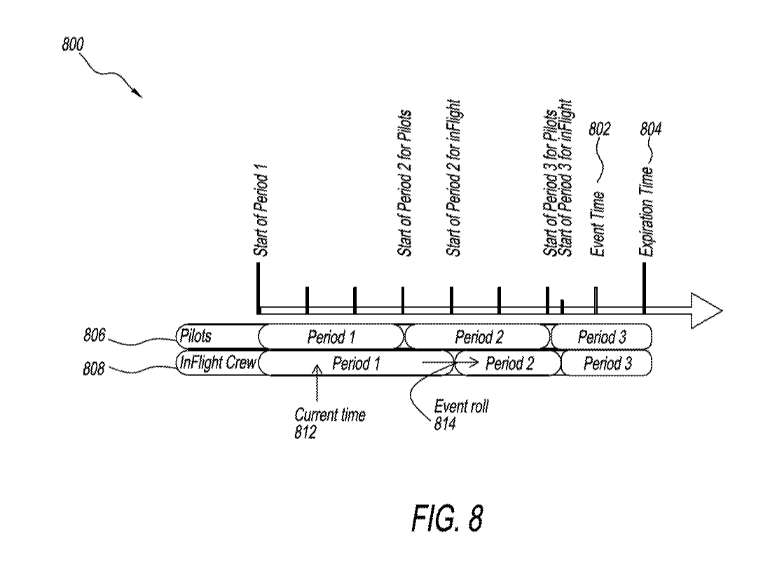

FIG. 8 is a timeline 800 which shows how event time periods may be adjusted for different classes of crew members. Event time periods are calculated based on the event time 802 and expiration time 804 of a schedule change. Event time periods for pilots 806 are shown in the first row and event time periods for inflight crew 808 are shown in the second row. A current time 812 is shown falling within period 1 for both pilots and inflight crew. The different event time periods may be defined by an airline, stored in a middleware database and used to determine push strategies based on job classification codes for crew members.

Occasionally there are large disruptions in air travel due, for example, to widespread storms (e.g. hurricanes), other natural disasters, or manmade events (e.g. plane crashes, war, terrorism, etc.) These disruptions are termed irregular operations or IROP. An airline may use different event time periods for an IROP and notify the middleware server of an IROP via an ad hoc notification 134 (FIG. 1). The middleware server would then use the IROP event time period definitions to determine push strategies for schedule change notifications.

In addition to using the event time period that a current time of schedule change detection falls in to determine push strategy, an “event roll” 814 may also be used to determine an additional push strategy. An event roll occurs when a schedule change is pushed to a crew member in one period but the crew member has not adequately responded to the schedule change notification by the start of the next period. This can be determined by the middleware server by looking up the event period the present time falls into and comparing that to the event period that the current time fell into when the schedule change was originally pushed. If the event periods are different, then an event roll has occurred. If the event period of the present time is period 2, then the event roll has been from period 1 to period 2. If the event period of the present time is period 3, then the event roll is from period 2 to period 3. When an even roll occurs, an additional push may be called for with an appropriate event roll push strategy. This would occur, for example, if an acknowledgeable notification has not been acknowledged.

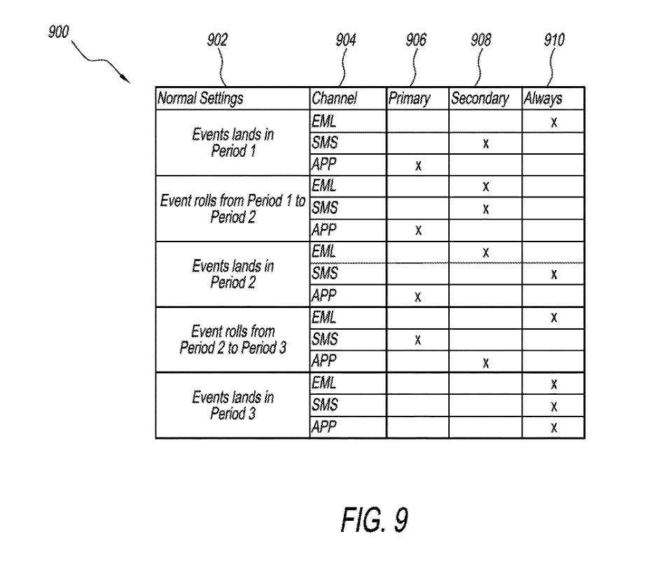

FIG. 9 is a push strategy lookup table 900 that may be stored on a middleware database to determine an appropriate push strategy for a schedule change record. The column “Normal settings” 902 specifies which period the schedule change (e.g. event) lands in, or rolls from. The column “Channel” 904 specifies which technology is used to push the schedule change record to the crew member. The technologies shown are email (EML), short message service (SMS) and mobile app push (APP). In general, email is low cost, reliable but relatively slow. Short message service is fast, high urgency but relatively expensive. Mobile app push is low cost and highly functional but can be intermittent. Other technologies can be incorporated in a lookup table, such as automated voice recognition to a mobile phone. The “Primary” column 906 shows which channel will be used first to push a schedule change record. If the primary channel fails to deliver after a certain number of tries, such as 3, or time period, such as 5 minutes, then the secondary channel 908 is used. The “Always” column 910 specifies a channel that is always used whether or not the primary or secondary channels succeed. In the example illustrated, if a schedule change event lands in period 1, the schedule change record is pushed to a crew member first by mobile app push. It is also pushed by email. If the mobile app push fails, then the relatively more expensive SMS push is used. The urgency of the notification is relatively low, so mobile app push and email are preferred so that the extra expense of an SMS is avoided. By contrast if a schedule change event falls in period 3, then the urgency is high and email, SMS and mobile App push are all used simultaneously.

The push strategy lookup table can be modified as needed depending upon how effective various strategies turn out to be.

### Mobile App

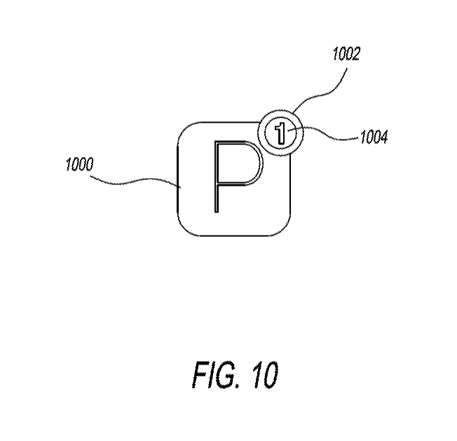

A notification system may comprise a mobile app loaded on a mobile device, such as a tablet computer. The mobile device may comprise an input and output device such as a touch screen. Mobile devices typically have a home screen where one or more icons to launch apps are displayed. FIG. 10 shows an exemplary home screen icon 1000 for a notification system mobile app. Any design may be used for the icon. The mobile app icon may comprise a badge icon 1002. This will appear proximate to the mobile app icon when there is a notification pushed to the mobile app that requires a crew member's action. By proximate it is meant that the badge icon will be close to or overlap the mobile app icon such that it is clear to a viewer that the badge icon applies to the app icon. The badge icon may comprise a badge count 1004 indicating how many notifications a crew member must attend to.

When a crew member or other person selects the home screen icon, the notification system mobile app may be launched. If the mobile device is in communication with the middleware server, such as by one or more of the internet, WiFi, or cellular network, or any other communications system, then the mobile device can synch with the middleware server. As described above, the mobile app will send a request to the middleware server for a schedule update and depending upon the version of the crew member's schedule the mobile app already has, the middleware server will either send a confirmation code that the crew member's schedule items are up to date, or will push an up to date set of schedule items to the mobile device. The middleware server may also push any schedule change records that have not been already pushed to the mobile device. The mobile app then uses the crew member's schedule items to display a calendar view of the crew member's schedule along with indications of the schedule change records that need the crew member's attention.

FIG. 11 shows a suitable calendar view 1100 on a mobile device screen. Other calendar designs may be used as well. The calendar view comprises a top navigation bar 1102, a calendar 1104 and a bottom status bar 1108. These can be arranged in any order. The navigation bar comprises one or more navigation icons. These icons may include a utility icon 1112, one or more notification icons 1114, 1116 and 1118 for different categories of notifications, a refresh icon 1122 and a “what's next” icon 1124. Other navigation icons, such as a change month icon 1126 may be provided as well. The notification icons comprise a schedule change/check-in icon 1114, hotel/ground transportation icon 1116 and an operational update icon 1118. Notifications may comprise a notification category field indicating which categories they belong to so that they can be identified and counted. A notification may belong to more than one category. The notification icons may each comprise a badge count icon 1120 with an indication of the number of notifications in each category that need a crew member's attention. This includes acknowledgeable notifications that have not been acknowledged.

The calendar 1104 may comprise dates organized by weeks over the period of a month. Dates before and after a given month may be greyed out 1140. The current date 1106 at the location of the crew member may be indicated visually, such as by a change in font color of the date's numeral relative to the font of the other dates. In this example, the numerals for dates within a given month are a dark grey and the numerals for the current day are red. Any visual indication, however, may be used. Within the calendar, ribbons 1132 are displayed for schedule items. The ribbons begin at about the local time of day that a schedule item begins and end at about the local time of day a schedule item ends. The length of a ribbon is not necessarily proportional to the duration of a schedule item since the start of the schedule item may be in one time zone and the end of the schedule item may be in another time zone. The order of the start and stop time may be reversed depending upon the time zones of the beginning and end of a schedule item. A visual indication may be given to alert a crew member when the start and stop times are reversed.

Different colors may be used for different ribbons depending upon the nature of the activity. A pairing 1132, for example, may be indicated in deep blue. An activity 1138 may be indicated in aquamarine. Any color scheme or shading scheme may be used. Each ribbon may comprise an identifier 1136, such as the pairing number for a pairing. Each ribbon may also comprise a ribbon badge icon 1134 indicating that the schedule item comprises notifications that require a crew member's attention. This includes acknowledgeable notifications that have not been confirmed by the middleware server as being acknowledged by a crew member. Both navigation icons and calendar ribbons are generally active and will display additional information upon selection by a crew member.

The status bar 1108 may be an indication of the status of communication between the mobile device and the middleware server. A green status bar may indicate that the mobile app is in communication with the middleware server and that the schedule change records and schedule items in the mobile device are up to date relative to the middleware server. A yellow or orange status bar may indicate that the mobile app is in communication with the middleware server, but that the schedule change records and schedule items are not up to date. This can occur, for example, during an IROP when the crew support services 112 (FIG. 1) have placed a hold on schedule updates 132 (FIG. 1). The hold can be provided to the middleware server through an ad hoc notification 134 (FIG. 1) and the middleware server, in turn, can send a status notification to the mobile device. In addition to simply notifying the crew member that there is a hold on schedule notifications, the mobile app may no longer be responsive to certain crew member actions, such as acknowledging a schedule change. The schedule change may be moot as the crew support services are reassigning crew members during the hold.

A red status bar may indicate to the crew member that the mobile device is not in communication with the middleware server. This can occur if the mobile device is not in communication with any local wireless portals to the internet, such as WiFi or a cellular network. Similar to the yellow status bar, the mobile app may no longer be responsive to certain crew member actions, such as checking in for a flight. The mobile app, however, may be partially responsive to other actions, such as viewing a notification.

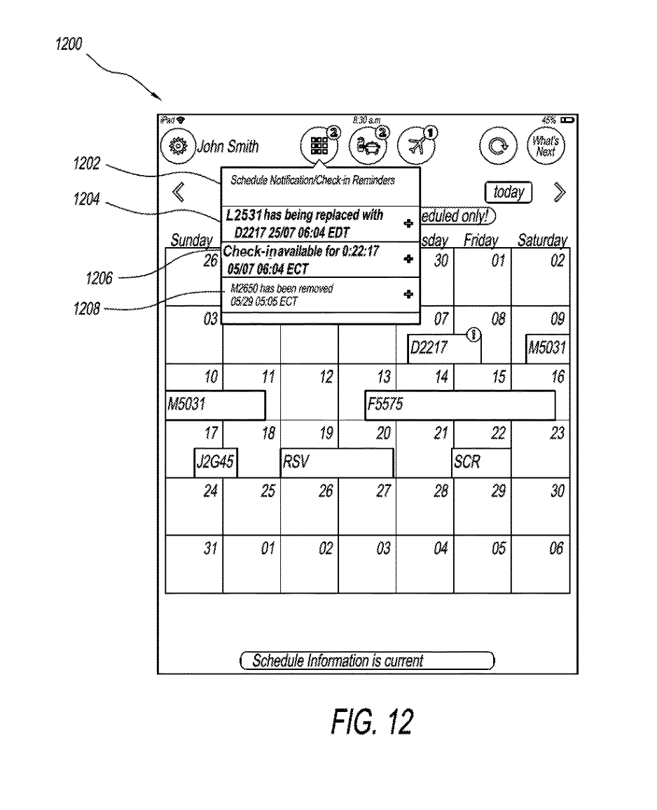

FIG. 12 shows a calendar view 1200 when the schedule notification/check-in icon has been selected by a crew member. The calendar has been greyed out and a schedule notification/check-in reminder popover 1202 is presented. The popover comprises a list of notifications and check-in reminders. Notifications 1204 and reminders 1206 that require action by the crew member are highlighted. Notifications and reminders that have been acted upon 1208 are shown in standard font, such as black. Any visual indication may be used. The notifications and check-in reminders may be links that cause the display of the associated unviewed notifications and check-in reminders upon selection.

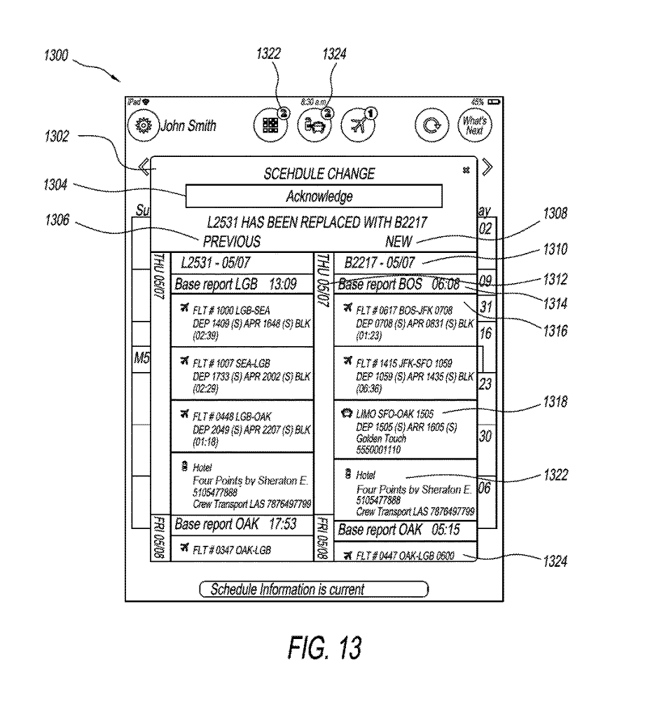

FIG. 13 shows a calendar view 1300 when a schedule change notification has been selected by a crew member. The calendar is greyed out and a schedule change popover 1302 is presented. The schedule change popover comprises an acknowledge button 1304 if the schedule change notification comprises an acknowledgeable notification. An acknowledgeable notification may comprise a field for indicating whether or not the notification has been acknowledged. The badge count may equal the sum of acknowledgeable notifications on the mobile device.

The schedule change popover also comprises a side by side column display of the previous schedule items 1306 and new schedule items 1308. If a schedule item is a pairing, its display may comprise an indication of pairing number 1310, duty periods 1312, report stations and times 1314 and a listing of flights 1316, ground transportation 1318, hotels 1322 and other items related to the pairing. The popover view may be scrollable 1324 so that the crew member can see additional items in the pairing that may not fit in the popover window.

Once the crew member selects the acknowledgement button, an acknowledgement is sent to the middleware server and a confirmation is returned to the mobile app. The badge icon 1322 on the schedule notification icon is then decremented. In this example, the badge icon 1324 on the hotel/ground transportation icon may also be decremented depending upon how many hotel/ground transportation items are in the pairing.

Hotel and ground transportation schedule items may be received by the middleware server from a booking service that is separate from the scheduling system 102 (FIG. 1). The items may have an indication of a pairing, but not of a specific crew member. The middleware server must therefore make the association between a hotel schedule item and a particular crew member's pairing. This can be done by comparing the booking dates of the hotel/ground transportation and the layover times of the pairing. Some airlines assign seat codes to hotel bookings that are indications of the type of crew member (e.g. pilot or flight attendant) and a number or rank (e.g. 1, 2, 3). These can also be used to assign hotel and ground transportation bookings to individual crew members. Sometimes hotel and ground transportation bookings arrive before pairings schedule changes arrive. These can be held in the middleware database until a suitable pairing arrives. If a hotel or ground transportation booking cannot be associated with a crew member, then the booking might be flagged for human review.

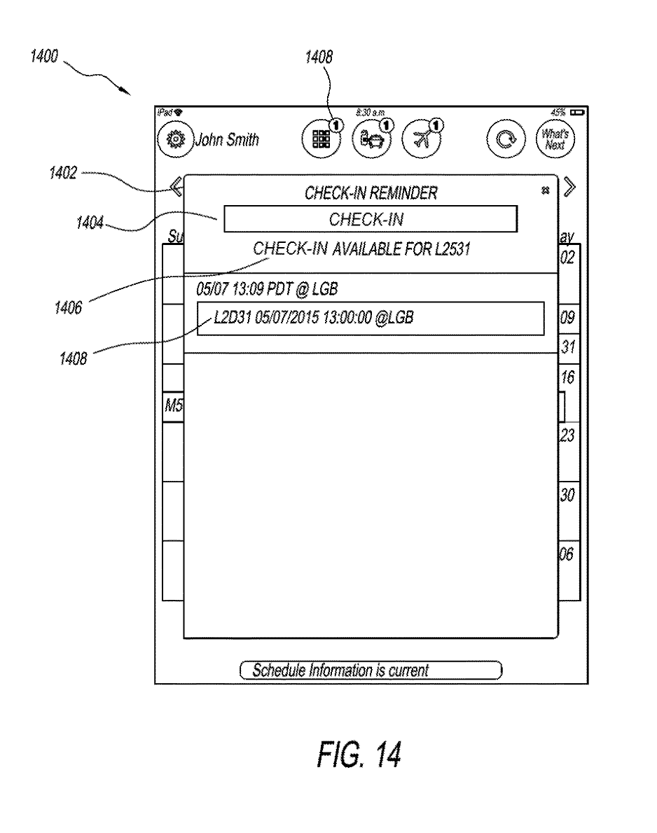

FIG. 14 shows a calendar view 1400 when a check-in reminder notification has been selected by a crew member. A check-in reminder is a type of acknowledgeable notification. The calendar is greyed out and a check-in popover 1402 is presented. The check-in popover comprises a check-in button 1404, an indication of check-in availability 1406 and a listing of the event 1408 the crew member is checking in for. Check-in availability may be based on being within a certain amount of time to a scheduled check-in and proximity to a check-in location. The allowable time for a check-in is referred to as an initial time window. The proximity to check-in location may be determined by a geofence. The geofence may be set up by the crew support services 112 (FIG. 1) or other authorized entity. One or more locations may be selected and their latitude and longitude may be forwarded to a crew member's mobile device along with an acceptable geofence radius. An acceptable radius may be 500 meters. There may be multiple locations in a single airport any of which would be acceptable for check-in. The locations may be within normal crew check-in rooms. The locations may be referred to as initial nodes. The crew member's mobile device may use a location determining technology, such as GPS, connection to a particular WiFi, or triangulation with local cell phone towers, to determine if the mobile device is within the acceptable radius of the geofence location. If other necessary conditions are met, then the mobile app will enable the check-in button. An example of a necessary condition is that the location is determined to be within a certain minimum accuracy, such as 100 meters. Once the enabled check-in button is selected by the crew member, the mobile device sends the check-in to the middleware server which then responds with a confirmation. The badge icon 1408 on the schedule/check-in icon then decrements. The system can also be set up so that the crew member is automatically checked in simply by being in a geofence during an initial time window for check-in (e.g. the period between the check-in time and reporting time). The crew member may be required to log in to the mobile device to verify the crew member's identity.

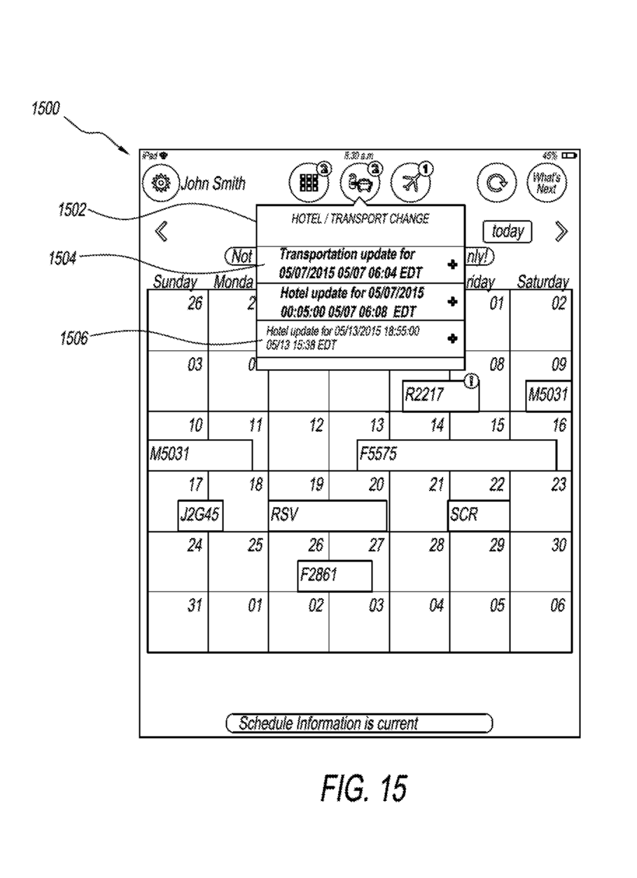

FIG. 15 shows a calendar view 1500 when the hotel/transport change icon has been selected by a crew member. The calendar has been greyed out and a hotel/transport change popover 1502 is presented. The popover comprises notifications 1504 that require the crew member's attention and notifications 1506 that have already been attended to.

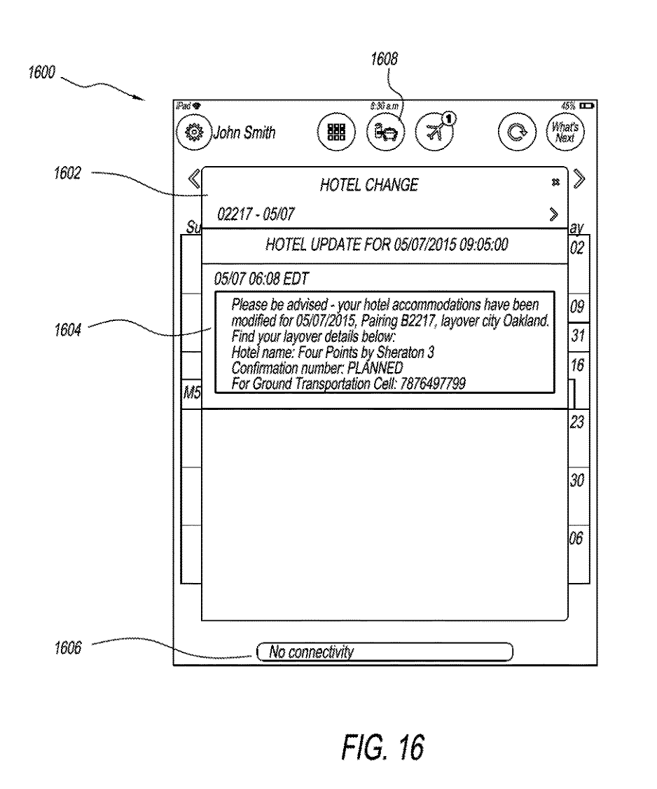

FIG. 16 shows a calendar view 1600 when a hotel/transport change notification has been selected by a crew member. The calendar is greyed out and a notification popover 1602 is presented. The notification popover comprises a notification 1604 that the crew member must view. An informational notification only requires that the crew member view it in order for the associated badge count icon 1608 to be decremented. In this case, the badge count was decremented to zero and the badge icon was no longer displayed. The decrement can be triggered either by the opening or closing of the informational notification. Each informational notification may comprise a field indicating whether or not said informational notification has been viewed. The badge count may be determined by counting the number of unviewed informational notifications stored on the mobile device.

The mobile device does not have to be in communication 1606 with the middleware server to decrement the badge icon. This is because confirmation by the server is not needed. The next time the mobile app is in communication with the middleware server, the mobile app will notify the server that the notification has been viewed and the server will update its records accordingly.

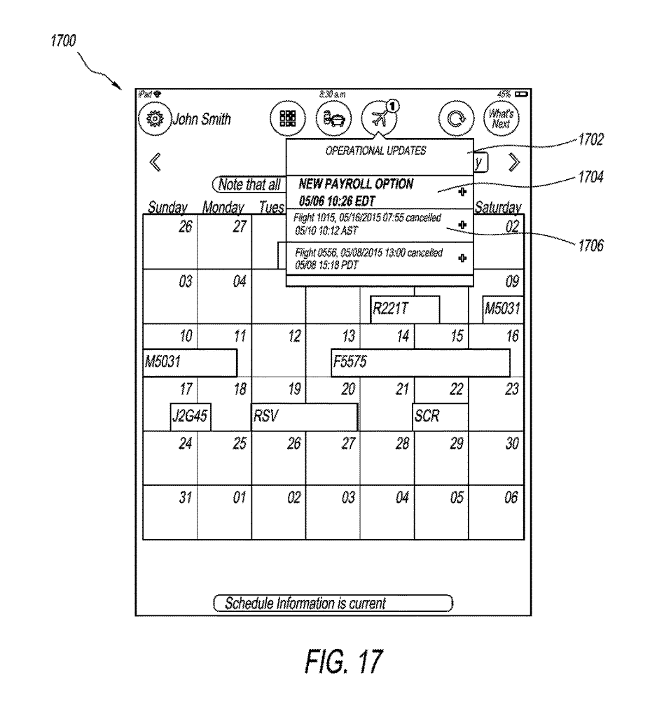

FIG. 17 shows a calendar view 1700 when the operational update icon has been selected by a crew member. The calendar has been greyed out and an operational update popover 1702 is presented. The popover comprises notifications 1704 that require the crew member's attention and notifications 1706 that have already been attended to.

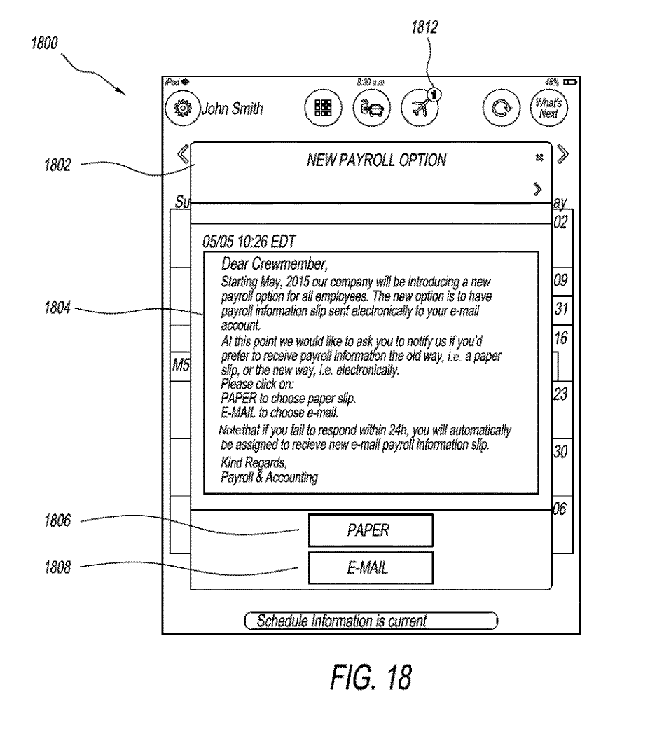

FIG. 18 shows a calendar view 1800 when an operational update notification has been selected by a crew member. The calendar is greyed out and an update popover 1802 is presented. The update popover comprises a notification 1804 that the crew member must view and respond to. The crew member is given a choice 1806 and 1808 of how to respond to the notification. A notification that requires a crew member to make a choice between two or more available options or provide other input is considered an acknowledgeable notification. After the crew member responds with a selection of one of said options, the selection is forwarded to the middleware server; the server responds with a confirmation; and the operational update badge number 1812 is decremented.

In addition to viewing schedule change records by selecting the notification icons at the top of the calendar view, a crew member or other person may view schedule change records as well as schedule items by selecting a ribbon on the calendar.

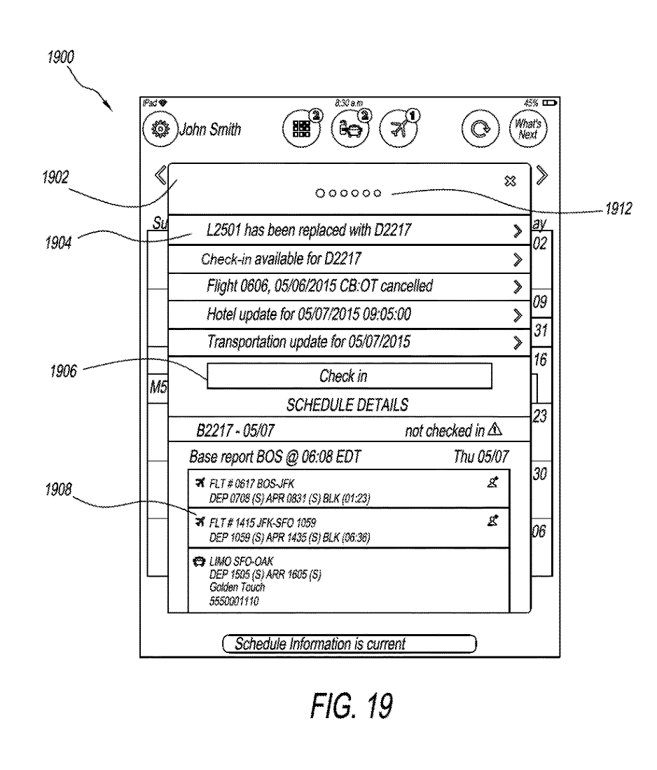

FIG. 19 shows a calendar view 1900 when a calendar ribbon has been selected by a crew member. The calendar has been greyed out and a ribbon popover 1902 is presented. The ribbon popover comprises notifications 1904 that require the crew member's attention, a check-in button 1906 if appropriate, and schedule items 1908 related to the ribbon. In this example, the ribbon is for a pairing. Scrolling buttons 1912 may be provided to assist the crew member in scrolling through the ribbon popover. Similar to the other notification popovers, the crew member can select a notification that requires attention and act accordingly. When all of the notifications have been attended to, the ribbon badge icon proximate to the ribbon will be removed. This includes acknowledgeable notifications that have been acknowledged and for which confirmations of the acknowledgements have been received from the middleware server.

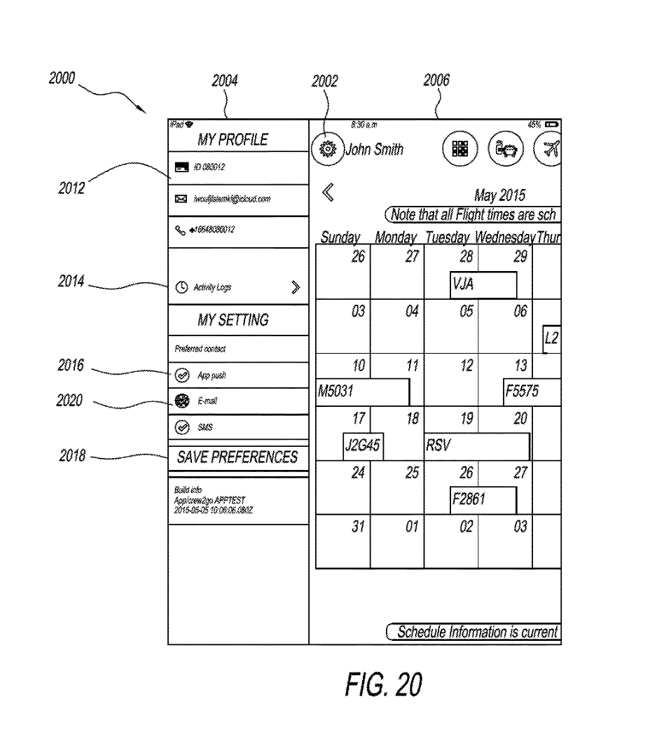

FIG. 20 shows a calendar view 2000 when a utility icon 2002 has been selected by a crew member. The calendar is greyed out and shifted to one side 2006 and a vertical profile bar 2004 is presented along the other side. Any convenient means may be used to display the profile bar. The profile bar may comprise personal information 2012 regarding the crew member, a link to an activity log 2014, selectable contact settings 2016 and a button for saving preferences 2018. For airline crew members, the personal information is generally obtained from the airline. If a crew member needs to update personal information, such as an email address, the update needs to be approved by the airline. This functionality can be provided in the app. The updated information provided by a crew member is forwarded to the airline but does not go into effect until confirmed by the airline. The contact settings, however, may be under the control of the crew member. A crew member can select which communications means (e.g. app push, e-mail or SMS) the crew member is willing to accept. There may be some minimum setting, such as at least one of the three or a required setting, such as email availability. A required setting may be greyed out 2020 to indicate that it is not selectable.

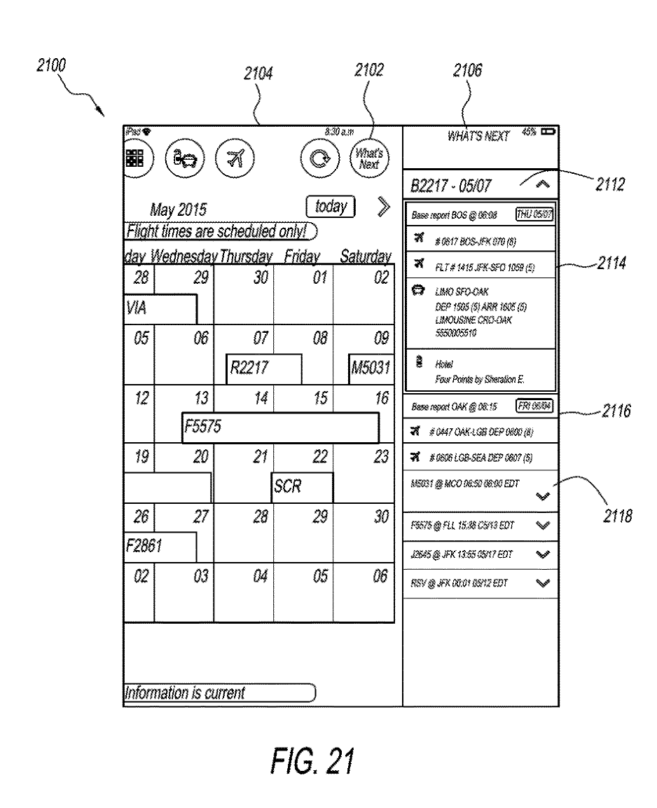

FIG. 21 shows a calendar view 2100 when a what's next icon 2102 has been selected by a crew member. The calendar is greyed out and shifted to one side 2104 and a vertical what's next column 2106 is presented along the other side. Any convenient means may be used to display the what's next bar. The what's next bar may comprise expandable listings 2112 of pairings and activities on a crew member's schedule that have not been completed yet. Upon selection of an activity or pairing, an expanded list 2114 of the schedule items associated with the event is presented. For pairings, the expanded list may be broken down by duties 2116. Unexpanded items 2118 may show event ID number, location of check-in, and check-in time.

Times displayed for any schedule item may be scheduled times, estimated times or actual times. An indication can be provided to show which type of time is shown.

### Cache Updating

The schedule item cache comprises one or more query results from the middleware database related to a crew member or other particular person's schedule items that have a start time and an end time that overlap a time interval specified in the query. The query results may be updatable as new schedule changes are detected for a crew member in a given query time interval. Whenever a query result is updated, it may be given a version number. The version number is the value of the global version number for said crew member at the time of the update.

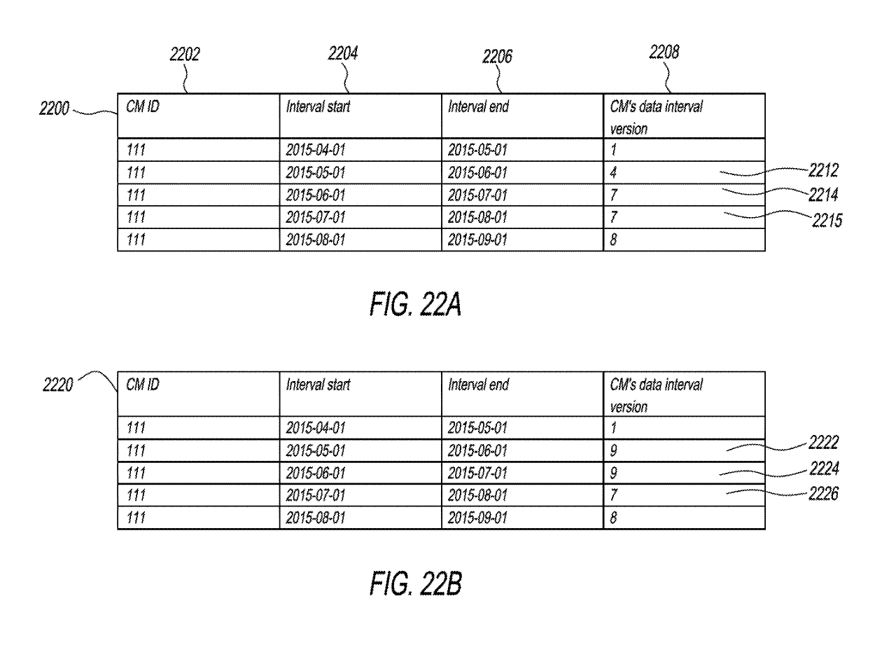

FIGS. 22A and 22B present version lookup tables indicating how version numbers for schedule item cache time intervals are updated. These tables may be stored in the middleware cache. Table 2200 has columns for crew member ID 2202, cache interval start 2204, cache interval end 2206 and crew member's monthly interval version number 2208. The monthly interval version number indicates the value of the crew member's global version number when the monthly interval cache was last updated. In this example, the May 2015 cache of schedule items for crew member 111 was last updated with global version 4 of the crew member's schedule items (item 2212). The June 2015 cache was last updated with version 7 (item 2214) and the July 2015 cache was also last updated also with version 7.

Table 2220 is the next version of the lookup table for crew member 111. It was updated after the 9^{th} global schedule change for the crew member was processed. The 9^{th} schedule change comprised changes for the activities in May of 2015 (item 2222) and June of 2015 (item 2224). Thus the version numbers for these months were set to 9. There was no changed item for July of 2015 so the version number remained 7 (item 2226).

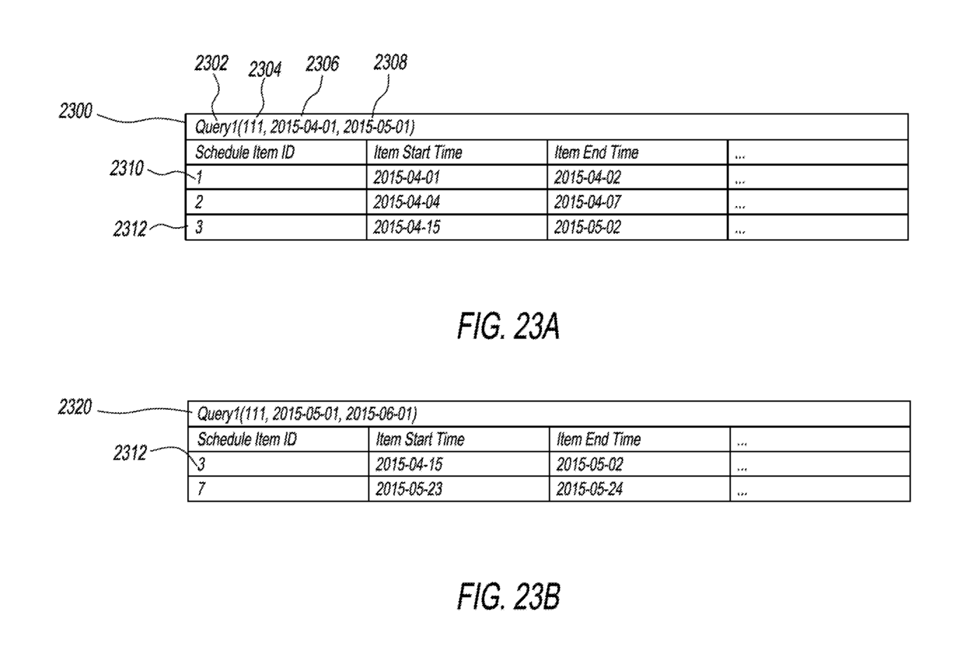

A crew member's schedule item cache for a given month (or other desired period, such as a week or day) comprises the results of schedule item queries run by the middleware server on the middleware database 116 (FIG. 1). These queries may be run in response to a request for a schedule update received from a crew member's mobile device. They may also be preemptively run to prepopulate a query before a request comes in. FIGS. 23A and 23B show tables of query results that may be saved in particular months of a crew member's schedule item cache. Table 2300 is for April of 2015 and table 2320 is for May of 2015. Different query types 2302 may be stored in the cache. Query1, as described herein, returns all schedule items 2310 for a particular crew member 2304 between a first date 2306 and a second date 2308. This date range is not inclusive of the second date in the sense that data only up to time 0:00 of the second date is returned. The schedule items may be indexed by a schedule item ID and may comprise a start time, end time and other fields related to the schedule item. If a portion of a schedule item falls outside of the query time interval, it is still returned by the query. Schedule item 3 (item 2312) is an example. It is returned for both the April query 2300 and the May query 2320.

When a schedule change for a crew member is detected by the middleware server, the query records associated with the changed schedule items must be located in the schedule item cache and updated. This can be facilitated by providing a hierarchy of keys and caching said keys.

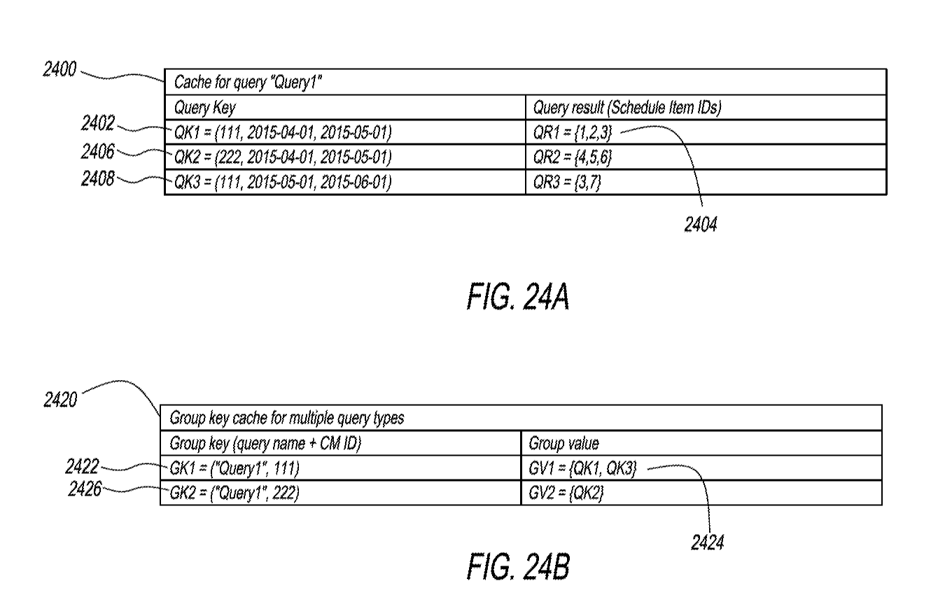

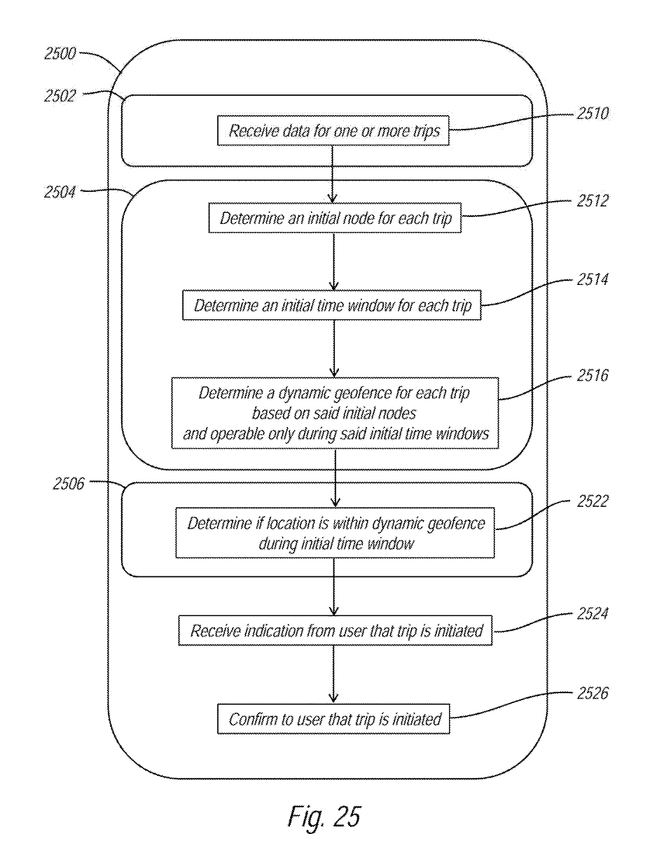

FIG. 24A illustrates a query key cache 2400 for a particular query type, “Query 1”. Each time query1 is run, a query key number is indexed and a query key comprising said query key number is placed in a query key cache. The query key 2402 comprises the crew member ID, start time, stop time and/or any other input fields to the query. The results of the query are labeled by the query key number and stored along with the schedule item IDs returned by the query (item 2404). As additional queries are run, the query key number is indexed and new records 2406 and 2408 are placed in the query key cache. Thus if a schedule change is processed, the schedule items that need to be updated in the schedule item cache can be readily identified using the crew member ID, start time of the changed schedule items and stop time of the changed schedule items. These give a query key, the query key gives the query results comprising the schedule items that need to be updated. If schedule times are added or removed from a query result, then the corresponding query result field can be updated in the query key cache.

If more than one query type is run by the middleware system, then a group key cache for multiple query types can be set up.

FIG. 24B illustrates a group key cache 2420. A group key number is indexed each time a new query type is run. The group key number 2422 is associated with a query type (e.g. Query1) and a crew member ID (e.g. 111). The group key cache has a field 2424 for the query keys associated with the query type and crew member ID. When a next query type is run (e.g. Query2) or a same query type but for a different crew member (e.g. crew member 222), the group key number is indexed and a new record 2426 is placed in the group key cache. Thus when a schedule change record is processed for a crew member and a particular query type, the proper query keys, and then associated schedule items can be quickly located so that they can be updated.

### Pseudo Code for Schedule Item Cache Updating

The follow pseudo code illustrates how the schedule item cache can be updated using the above described keys.

Cache put operation

// Put query result into cache
cache.put(queryKey, queryResult);
// Additionally add key to cached keys for related group
groupKey = createGroupKey(queryKey);
groupValue = cache.get(groupKey);
groupValue.addKey(queryKey);
cache.put(groupKey, groupValue);

Cache get operation

// Get cached query result
queryResult = cache.get(queryKey);
return queryResult;

Cache addValue(queryParams, cacheCriteria, addToQueryResult)
operation
// Get all keys for this group

groupKey = createGroupKey(queryParams);
groupValue = cache.get(groupKey);
// For each query key update cached values
for (queryKey : groupValue.keys( ) {

if (cacheCriteria.isSatisfied(queryParams)) {

queryResult = cache.get(queryKey);
queryResult.add(addToQueryResult);
cache.put(queryKey, queryResult);

}

}

Cache removeValue(queryParameters, cacheCriteria,
removeFromQueryResult) operation
// Get all keys for this group

groupKey = createGroupKey(queryParams);
groupValue = cache.get(qroupKey);
// For each query key update cached values
for (queryKey : groupValue.keys( ) {

if (cacheCriteria.isSatisfied(queryParams)) {

queryResult = cache.get(queryKey);
queryResult.remove(removeFromQueryResult);
cache.put(queryKey, queryResult);

}

}

### Actual Example

In an actual example, a schedule notification system as described herein was implemented on an evaluation basis with certain crew members of an airline. The crew members each had a mobile device running the mobile calendar app. The total data traffic to the crew members' portable devices was monitored. It was found that the traffic decreased by at least 50% due to the use of a schedule item cache updated using query keys and group keys as described herein.

### CONCLUSION

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this invention.

We claim:

1. A system for dynamic geofence determination, comprising:
a) an interface configured to receive data for one or more trips; and
b) a first microprocessor configured to:
i) determine an initial node for each trip, wherein said initial nodes are based at least in part on said data;
ii) determine an initial time window for each trip, wherein said initial time windows are based at least in part on said data; and
iii) determine a dynamic geofence for each trip based on said initial nodes and operable during said initial time windows.

2. The system for dynamic geofence determination of claim 1 wherein:
a) said interface comprises a location sensor to determine a location of said interface; and
b) said first microprocessor is configured to:
i) receive through said interface an indication from a user that said user has initiated a first trip when said location is within a dynamic geofence associated with said first trip during said first trip's initial time window, said first trip being one of said trips; and
ii) confirm to said user through said interface that said first trip has been initiated.

3. The system for dynamic geofence determination of claim 2 wherein said first microprocessor is further configured to:
a) receive an update to said data for said one or more trips;
b) change at least one of said initial nodes or said initial time windows based on said update to said data; and
c) update at least one of said dynamic geofences based on said changes to said initial nodes or initial time windows.

4. The system for dynamic geofence determination of claim 3 wherein:
a) said interface is configured to accept a login associated with said user and confirm said user's identity; and
b) said first microprocessor is configured to automatically initiate said first trip when said interface is with within said dynamic geofence associated with said first trip during said initial time window associated with said first trip.

5. The system for dynamic geofence determination of claim 2 wherein said location sensor comprises a global positioning system.

6. The system for dynamic geofence determination of claim 1 comprising:
a) a computer based middleware server comprising:
i) a microprocessor in communication with a permanent memory; and
ii) a middleware database; and
b) a computer based mobile device registered to a particular person, said mobile device comprising:
i) a microprocessor in communication with a permanent memory; and
ii) a screen;
wherein:
c) said middleware server is in communication with a computer based scheduling system;
d) said middleware permanent memory comprises computer executable instructions to cause said middleware server to perform the steps of:
iii) receive a new schedule item extract from said scheduling system, said new schedule item extract comprising one or more new schedule items, said one or more new schedule items each comprising:
1) a description;
2) an item ID;
3) a person ID;
4) a date;
5) a local start time; and
6) a local end time;
iv) receive an old schedule item extract from said middleware database, said old schedule item extract comprising one or more old schedule items which were previously extracted from said scheduling system, said one or more old schedule items each comprising:
1) a description;
2) an item ID;
3) a person ID;
4) a date;
5) a local start time; and
6) a local end time;
v) determine by at least said item IDs, person IDs and dates, a change in one or more of said schedule items for said particular person, said change in said schedule items being at least one of:
1) an old schedule item for said particular person that has been modified;
2) old schedule item for said particular person that has been deleted; and
3) a new schedule item for said particular person has been added;
vi) determine by at least said start times and said end times one or more schedule change records for said particular person, said schedule change records comprising sets of one or more of said old and new schedule items for said particular person that are overlapping in time with each other and at least one of said changed schedule items;
vii) pushing at least one of said schedule change records for said particular person to said mobile device; and
viii) replacing said old extract with said new extract in said middleware database;
and wherein:
e) said computer based mobile device is said interface;
f) said mobile device microprocessor is said first microprocessor;
g) said schedule items are said one or more trips; and
h) said one or more initial time windows are associated with said local start times.

7. The system for dynamic geofence determination of claim 6 wherein said middleware server comprises a schedule item cache and said schedule item cache comprises one or more updatable query results from said middleware database wherein each of said query results comprises schedule items that:
a) are associated with said particular person;
b) have a start time and end time that overlap a query time interval; and
c) a version number indicating the number of schedule change records that had occurred for said particular person when said query result was last updated in said schedule item cache.

8. The system for dynamic geofence determination of claim 7 wherein said middleware computer executable instructions are operable to cause said middleware server to perform the steps of:
a) update said schedule item cache based on said schedule change records;
b) receive a schedule update request for a given query time interval for said particular person from said mobile device, said update request comprising an old version number for said given query time interval current as of the last prior schedule update request from said mobile device for said given query time interval; and
c) compare said old version number from said mobile device with the current version number for said given query time interval in said schedule item cache and:
i) return a confirmation code to said mobile device if said old version number and said current version number match; or
ii) return the schedule items for said query time interval in said schedule item cache and said current version number to said mobile device if said old version number and said cache version number do not match.

9. The system for dynamic geofence determination of claim 8 wherein said mobile device permanent memory comprises computer executable instructions operable to cause said mobile device microprocessor to carry out the steps of:
a) display previously received schedule items in a calendar view when said mobile device receives said confirmation code from said middleware server; or
b) display said returned schedule items in said calendar view when said mobile device receives said returned schedule items and store said returned schedule items and said current version number in said permanent memory of said mobile device
wherein:
c) at least one of said displayed schedule items starts in one time zone and ends in another time zone;
d) said calendar view is for a calendar period; and
e) said calendar view comprises a visual indication of the local start time and local end time of each of said displayed schedule item that starts or ends within said calendar period.

10. The system for dynamic geofence determination of claim 6 wherein:
a) said one or more pushed schedule change records comprise one or more informational notifications and said informational notifications comprise a field indicating whether or not an information notification has been viewed on said mobile device; and
b) said mobile device permanent memory comprises computer executable instructions operable to cause said mobile device microprocessor to carry out the steps of:
i) count the number of informational notifications that have not been viewed;
ii) display said count in a badge icon proximate to an icon displayed on said screen;
iii) display a link to each of said unviewed notifications upon selection of said icon by a user of said mobile device;
iv) display an unviewed notification on said screen upon selection of said unviewed notification's link;
v) decrement said count by 1 upon either the opening or closing of said unviewed notification; and
vi) send a confirmation to said middleware server that said opened notification has been viewed.

11. The system for dynamic geofence determination of claim 6 wherein:
a) said one or more pushed schedule change records comprise one or more acknowledgeable notifications and said acknowledgeable notifications comprise a field indicating whether or not said acknowledgeable notification has been acknowledged on said mobile device; and
b) said mobile device permanent memory comprises computer executable instructions operable to cause said mobile device microprocessor to carry out the steps of:
i) count the number of acknowledgeable notifications that have not been acknowledged;
ii) display said count in a badge icon proximate to an icon displayed on said screen;
iii) display a link to each of said unacknowledged notifications upon selection of said icon by a user of said mobile device;
iv) display an unacknowledged notification on said screen upon selection of said unacknowledged notification's link;
v) receive an acknowledgement from a user of said mobile device;
vi) forward said acknowledgement to said middleware server;
vii) receive a confirmation of said acknowledgement from said middleware server; and
viii) decrement said count by 1 upon receipt of said acknowledgement.

12. The system for dynamic geofence determination of claim 11 wherein:
a) said acknowledgeable notification is a check-in notification; and
b) said mobile device permanent memory comprises computer executable instructions operable to cause said mobile device microprocessor to carry out the steps of:
i) determine if said mobile device is within a geofence associated with said check-in;
ii) allow said check-in when said mobile device is within said geofence; or
iii) prevent said check-in when said mobile device is outside of said geofence.

13. The system for dynamic geofence determination of claim 11 wherein said acknowledgeable notification comprises a choice of two or more options available to said user of said mobile device and wherein said acknowledgment comprises the selection of one of said options.

14. The system for dynamic geofence determination of claim 11 wherein said pushed schedule change records comprise one or more informational notifications and wherein said count comprises the total number of unacknowledged acknowledgeable notifications and unviewed informational notifications.

15. The system for dynamic geofence determination of claim 11 wherein:
a) said acknowledgeable notifications comprise a notification category field indicating that said acknowledgeable notification is one or more of a schedule notification/check-in reminder, a hotel/transport change, or an operational update; and
b) said mobile device permanent memory comprises computer executable instructions operable to cause said mobile device microprocessor to carry out the steps of:
i) count the number of unacknowledged notifications in each notification category; and
ii) display on said screen a badge icon indicating the total number of said unacknowledged notifications for each notification category proximate to an icon for each notification category.

16. The system for dynamic geofence determination of claim 11 wherein:
a) said acknowledgeable notifications are associated with a schedule item displayed as a ribbon in a calendar view on said screen of said mobile device; and
b) said mobile device permanent memory comprises computer executable instructions operable to cause said mobile device microprocessor to carry out the steps of:
i) display a ribbon badge icon proximate to said schedule item displayed in said calendar view;
ii) display a list of said acknowledgeable notifications on said screen over said calendar view upon selection of said schedule item by a user of said mobile device;
iii) display a selected acknowledgeable notification upon selection of said selected acknowledgeable notification item from said list;
iv) receive an acknowledgement to said selected acknowledgeable item from said user;
v) forward said acknowledgement to said middleware server;
vi) receive from said middleware server a confirmation of said acknowledgement; and
vii) remove said ribbon badge icon from said schedule item displayed on said calendar when a confirmation has been received for all of said acknowledgeable notifications displayed on said list.

17. The system for dynamic geofence determination of claim 16 wherein said middleware permanent memory comprises computer executable instructions to cause said middleware server to perform the steps of:
a) receive said acknowledgement from said mobile device; and
b) forward said acknowledgement to said scheduling system.

18. The system for dynamic geofence determination of claim 6 wherein:
a) said middleware server is operable to push said schedule change record to said mobile device by one or more pushing means comprising:
i) an email comprising a deep link for acknowledging an acknowledgeable notification;
ii) a short message service comprising a random code for acknowledging an acknowledgeable notification; or
iii) a push message to an app resident on said mobile device; and
b) said middleware permanent memory comprises computer executable instructions to cause said middleware server to perform the steps of:
i) determine an event time and a current time for a particular schedule change record;
ii) calculate a first, second and third event period prior to said event time, said first event period being prior to said second event period and said second event period being prior to said third event period;
iii) determine if the current time falls within said first, second or third event period;
iv) determine by a push strategy lookup table which of said pushing means said schedule change record should be pushed to said mobile device based on which event period said current time falls in; and
v) push said schedule change record by said one or more looked up pushing means.

19. The system for dynamic geofence determination of claim 18 wherein:
a) said push strategy lookup table comprises a primary pushing means, a secondary pushing means and an always pushing means for each of said event periods; and
b) said middleware permanent memory comprises computer executable instructions to cause said middleware server to perform the steps of:
i) push said schedule change record to said mobile device by the primary means listed in said push strategy lookup table for the event period said current time falls in;
ii) push said schedule change record to said mobile device by the secondary means listed in said push strategy lookup table for the event period said current time falls in when said primary means fails to deliver said schedule change record to said mobile device; and
iii) push said schedule change record to said mobile device by the always means listed in said push strategy lookup table for the event period said current time falls in.

20. The system for dynamic geofence determination of claim 19 wherein:
a) said pushed schedule change record comprises an acknowledgeable notification;
b) said push strategy lookup table comprises primary, secondary and always pushing means for when an event rolls from a first event period to a second event period and for when an event rolls from a second event period to a third event period; and
c) said middleware permanent memory comprises computer executable instructions to cause said middleware server to perform the steps of:
i) determine if the present time has rolled from a first event period to a second event period or from a second event period to a third event period;
ii) determine if said pushed acknowledgeable notification has been acknowledged; and
iii) push said schedule change record again to said mobile device by first the primary, next the secondary if the primary fails, and always the always pushing means associated with said determined event roll when said acknowledgeable notification has not been acknowledged.

21. The system for dynamic geofence determination of claim 20 wherein:
a) said pushed schedule change record comprises an old schedule item and a new schedule item and each old and new schedule item comprises a pairing with a check-in time, a duty within said pairing with a report time and a flight within said duty with a departure time; and
b) said middleware permanent memory comprises computer executable instructions to cause said middleware server to perform the steps of:
i) determine the earliest changed pairing check-in time, duty report time, or flight departure time for said old and new schedule items that is after said current time; and
ii) set said event time to said earliest changed time.

22. The system for dynamic geofence determination of claim 18 wherein said middleware permanent memory comprises computer executable instructions to cause said middleware server to perform the steps of:
a) receive a number and duration of event time periods specific to a job function of said particular person and a work condition of said particular person;
b) determine said job function and work condition of said particular person at said current time; and
c) determine said event time period that said push notification falls in based at least in part on said job function and work condition.

23. The system for dynamic geofence determination of claim 22 wherein said work condition is a normal operation or an irregular operation.
